(19) United States
(12) Patent Application Publication
(10) Pub. No.: US 2026/0048973 A1
(43) Pub. Date: Feb. 19, 2026

(54) SYSTEM AND METHOD FOR LIFTING AND INSTALLING BUILDING COMPONENTS

(71) Applicant: Yolda Works, LLC, Gillette, WY (US)

(72) Inventors: Terry Harmer, Gillette, WY (US); Tracy Harmer, Gillette, WY (US)

(73) Assignee: Yolda Works, LLC, Gillette, WY (US)

(21) Appl. No.: 18/805,465

(22) Filed: Aug. 14, 2024

(51) Int. Cl. B66F 19/00

(52) U.S. Cl. CPC B66F 19/00

(57) ABSTRACT

Certain aspects of the disclosure provide a system and method for lifting and installing building components. In examples, the system may include a plurality of cable winches adapted to be connected to a ceiling structure; a plurality of cables, each cable having a first end connected to one of the cable winches and a second end adapted to be connected to the ceiling structure, wherein each cable of the plurality of cables is coupled to a pre-assembled building component; and a control mechanism for operating the cable winches simultaneously to lift the pre-assembled building component into a final location for installation.

### BACKGROUND

### Field

Aspects of the present disclosure relate to systems and methods for lifting and installing building components.

### Description of Related Art

In the construction industry, the installation of various building components such as conduit, data cable trays, HVAC duct work, water piping, fire sprinkler pipes, and drop ceiling frames often requires significant time and effort. Traditionally, these components are installed piece by piece, with each component being individually lifted and secured to the ceiling structure. This process is labor-intensive, time-consuming, and often requires the use of scaffolding or other lifting equipment to reach the installation height.

The installation of building components typically involves multiple steps, including measuring, cutting, and assembling the components on-site. This process can lead to errors and inconsistencies, as well as increased labor costs and potential safety hazards associated with working at heights. Additionally, the use of scaffolding or lifting equipment can create obstacles and limit the available workspace, further complicating the installation process.

In some cases, pre-assembled building components are used to reduce on-site installation time. However, even with pre-assembled components, the process of lifting and securing these components to the ceiling structure remains challenging. The weight and size of the pre-assembled components can make them difficult to maneuver, and the use of traditional lifting methods, such as cranes or manual labor, can be inefficient and pose safety risks.

As building projects become increasingly complex and time-sensitive, there is a growing need for more efficient and streamlined methods of installing building components. Contractors and building owners are seeking solutions that can reduce labor costs, minimize installation time, and improve overall project efficiency. Furthermore, there is a demand for installation methods that prioritize worker safety and reduce the need for scaffolding or other temporary lifting structures.

### SUMMARY

Certain aspects provide a system for lifting and installing building components. In certain aspects, the system includes: a plurality of cable winches configured for attachment to a ceiling structure; a plurality of cables, each having a first end connected to one of the cable winches and a second end configured for connection to the ceiling structure, where each cable is coupled to a pre-assembled building component; and a control mechanism designed to operate the cable winches simultaneously to elevate the pre-assembled building component to its final installation location.

Certain aspects provide a method for installing building components. In certain aspects, the method includes: attaching a plurality of cable winches to a ceiling structure; connecting a first end of each of several cables to one of the cable winches; coupling each cable to a pre-assembled building component; connecting a second end of each cable to the ceiling structure; and operating the cable winches simultaneously to lift the pre-assembled building component to its final installation location.

Certain aspects provide a lifting system for installing building components. In certain aspects, the lifting system includes: a plurality of cable winches configured for connection to a building structure; a plurality of cables, each cable having a first end connected to one of the cable winches and a second end configured for connection to the building structure; a support bracket designed for coupling to the building structure; at least one accessory selected from a group consisting of a pulley assembly and a sleeve assembly, each accessory facilitating the coupling of each cable of the plurality of cables to a pre-assembled building component; and a control mechanism for operating the cable winches simultaneously to lift the pre-assembled building component into its final installation location.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1A depicts a system for lifting and installing building components shown in a lowered assembly phase, where various elements work together to position pre-assembled components, in accordance with examples of the present disclosure.

FIG. 1B depicts another system for lifting and installing building components shown in a lowered assembly phase, where various elements work together to position pre-assembled components, in accordance with examples of the present disclosure.

FIG. 2A illustrates a system in a raised assembly phase where the pre-assembled building components may be secured to a previously installed support bracket, in accordance with examples of the present disclosure.

FIG. 2B depicts another system in a raised assembly phase where the pre-assembled building components may be secured to a previously installed support bracket, in accordance with examples of the present disclosure.

FIG. 3 shows a system for lifting and installing building components in a lowered assembly phase where a support bracket is attached to the pre-assembled building components before being raised, in accordance with examples of the present disclosure.

FIG. 4 depicts the system in a raised assembly phase where a support bracket coupled to the pre-assembled building components can be attached to one or more ceiling attach points, in accordance with examples of the present disclosure.

FIG. 5 illustrates a system for lifting and installing building components in a lowered assembly phase where a support bracket may be attached to a data tray assembly, allowing secure attachment of the pre-assembled building components prior to being raised, in accordance with examples of the present disclosure.

FIG. 6 shows the system in a raised assembly phase where the support bracket can be coupled to one or more ceiling attach points or to another support bracket, in accordance with examples of the present disclosure.

FIG. 7 depicts a system for lifting and installing building components particularly focusing on the installation of a pre-assembled duct in a lowered assembly phase, in accordance with examples of the present disclosure.

FIG. 8 illustrates the system in a raised assembly phase where the pre-assembled building components, exemplified as a duct, are connected to the support bracket, in accordance with examples of the present disclosure.

FIG. 9 provides additional details of the pulleyed sleeve assembly, a component of the system for lifting and installing building components such as ducts or pipes, in accordance with examples of the present disclosure.

FIG. 10 shows an example communication system that can be used to control and operate the cable winches in the system for lifting and installing building components, in accordance with examples of the present disclosure.

FIG. 11 illustrates a method for installing building components using a system of cable winches and cables, detailing a sequential process for the efficient and safe installation of building components in a construction setting, in accordance with examples of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for lifting and installing building components, such as conduit, data cable trays, HVAC duct work, water piping, fire extinguisher pipes, and drop ceiling frames, in a more efficient and streamlined manner.

The present disclosure describes a system for lifting and installing pre-assembled building components using a combination of cable winches, support brackets, and optional accessories such as pulley assemblies and sleeve assemblies. In certain aspects, the system allows for the pre-assembly of building components at ground level, which are then lifted into place using the cable winches and secured to the ceiling structure using the support brackets. This approach can significantly reduce the time and labor required for on-site assembly and installation, while also improving safety by minimizing the need for workers to perform tasks at elevated heights.

In the construction industry, installing various building components can be a labor-intensive, time-consuming, and potentially hazardous process. Traditionally, these components are installed piece by piece, often requiring the use of scaffolding or lifting equipment to reach the installation height. This approach can lead to inconsistencies, increased labor costs, and safety risks associated with working at heights. Additionally, the use of scaffolding or lifting equipment can create obstacles and limit the available workspace, further complicating the installation process.

The system described in the present disclosure addresses these problems by providing a versatile and adaptable solution for lifting and installing pre-assembled building components. The system include the use of cable winches to lift the components, support brackets to secure the components to the ceiling structure, and optional accessories such as pulley assemblies and sleeve assemblies to facilitate the lifting process. By allowing for the pre-assembly of building components at ground level and then lifting them into place, the system streamlines the installation process and reduces the need for overhead work.

The technical solution provided by the present disclosure offers several benefits and advantages. Firstly, it can reduce the time and labor required for on-site assembly and installation, leading to lower labor costs and faster project completion times. Secondly, it can improve worker safety by minimizing the need for tasks to be performed at elevated heights, reducing the risk of accidents and injuries. Thirdly, the system can allow for greater precision and quality control, as the pre-assembled components can be thoroughly inspected and tested before being lifted into place. Finally, the versatility and adaptability of the system can make it suitable for a wide range of building components and installation scenarios, offering a more efficient and cost-effective approach to building component installation.

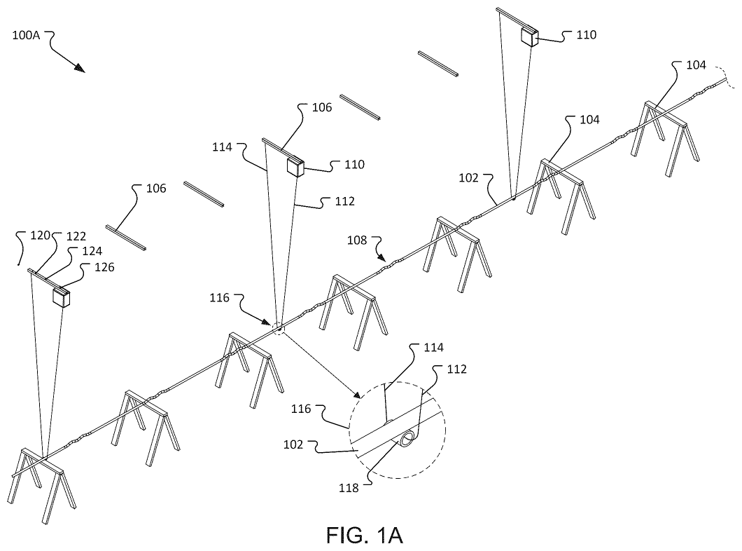

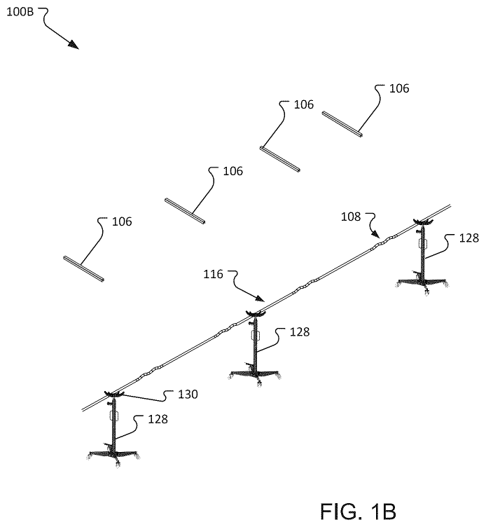

FIG. 1A illustrates a system 100A for lifting and installing building components, shown in a lowered assembly phase, in accordance with examples of the present disclosure. In certain aspects, the lowered assembly phase allows for convenient access to the pre-assembled building component(s) 102, enabling preparations or adjustments to be made prior to the lifting process. In certain aspects, the system 100A comprises various elements that work together to efficiently lift and position pre-assembled building components, such as conduit sections containing cables, into their final installation location.

The pre-assembled building component(s) 102 can include a variety of elements, such as conduit sections, which may be used for routing data/telecom cables, electrical/power cables, or a combination thereof. In certain aspects, the pre-assembled building component(s) 102 may incorporate a flexible portion 108, which can be an integral part of the conduit section. This flexible portion 108 may allow for some degree of movement or flexing during the lifting and installation process, helping to prevent damage to the conduit and the cables contained within. In some aspects, the flexible portion 108 may be a conduit and/or a cable assembly as described further with respect to U.S. patent application Ser. No. 18/805,461, which is herein incorporate by reference for tall that it teaches and for all purposes.

To support the pre-assembled building component(s) 102 during the assembly and lifting process, a buckhorse 104 may be provided. The buckhorse 104 can serve as a temporary support structure, allowing the pre-assembled building component(s) 102 to be easily accessed and manipulated during the lowered assembly phase. The buckhorse 104 may be adjustable in height and may include various features, such as shelves or brackets, to accommodate different types and sizes of building components.

A support bracket 106 can be used to secure the pre-assembled building component(s) 102 to the ceiling structure. The support bracket 106 may be designed to attach to specific ceiling attach points, which can be pre-installed or installed during the lifting process. In some aspects, the support bracket 106 may be a Unistrut® or similar type of support system, which allows for flexible positioning and attachment of the pre-assembled building component(s) 102. In some aspects, the support bracket 106 may be pre-installed on the ceiling structure prior to the lowered assembly phase. This pre-installation of the support bracket 106 can further streamline the installation process, as it may eliminate the need to install the support bracket 106 during the lifting and installation of the pre-assembled building component(s) 102. The pre-installed support bracket 106 can be designed to accommodate various types of ceiling attach points and can be easily adjusted to ensure proper alignment and positioning of the pre-assembled building component(s) 102 during the raised assembly phase.

In some aspects, the system 100A may utilize multiple cable winches 110 working together to lift the pre-assembled building component(s) 102. Each cable winch 110 can be mounted to a ceiling attach point(s) 126 and may operate in conjunction with a corresponding cable. The use of multiple cable winches 110 and cables can provide a more stable and controlled lifting process, distributing the weight of the pre-assembled building component(s) 102 evenly and reducing the risk of damage or deformation.

The cables used in the system 100A may each include a first end 112 and a second end 114. In examples, the first end 112 of each cable can be connected to a corresponding cable winch 110, while the second end 114 may be secured to a respective ceiling attach point 120. The cables can be routed under the pre-assembled building component(s) 102, either directly or through an under component sleeve assembly 116, which may be optional in certain embodiments.

When present, the under component sleeve assembly 116 may include a sleeve 118, which can be positioned between the cables and the pre-assembled building component(s) 102. The sleeve 118 may be made of a durable, low-friction material, such as plastic or nylon, to allow the cables to slide smoothly during the lifting process. In certain aspects, the sleeve 118 may also help to distribute the weight of the pre-assembled building component(s) 102 evenly, minimizing the risk of damage or deformation to the conduit and cables.

The system 100A may include several ceiling attach points, which can be used to secure the various components of the lifting system. In examples, ceiling attach points 122 and 124 may be used to secure the support bracket 106, while ceiling attach point 126 can be used to secure one or more cable winches 110. The specific configuration and number of ceiling attach points may vary depending on the particular installation requirements and the layout of the building structure.

By utilizing the system 100A in the lowered assembly phase, pre-assembled building component(s) 102, such as conduit sections containing cables, can be efficiently prepared and positioned for the lifting process. The use of multiple cable winches 110 and cables, along with optional components like the under component sleeve assembly 116, can provide a safe, stable, and controlled lifting process, minimizing the risk of damage to the building components and ensuring a successful installation.

FIG. 1B illustrates a system 100B for lifting and installing building components, shown in a lowered assembly phase, in accordance with examples of the present disclosure. In certain aspects, the lowered assembly phase allows for convenient access to the pre-assembled building component(s) 102, enabling preparations or adjustments to be made prior to the lifting process. In certain aspects, the system 100B comprises various elements that work together to efficiently lift and position pre-assembled building components, such as conduit sections containing cables, into their final installation location.

To support the pre-assembled building component(s) 102 during the assembly and lifting process, a lift 128 may be provided. The lift 128 can serve as a temporary support structure, allowing the pre-assembled building component(s) 102 to be easily accessed and manipulated during the lowered assembly phase. The lift 128 may be adjustable in height and may include various features, such as shelves or brackets, to accommodate different types and sizes of building components. In some examples, a saddle 128 may support one or more of the pre-assembled building component(s) 102.

In some aspects, the system 100B may utilize multiple lifts 128 working together to lift the pre-assembled building component(s) 102. The use of multiple lifts 128 can provide a more stable and controlled lifting process, distributing the weight of the pre-assembled building component(s) 102 evenly and reducing the risk of damage or deformation.

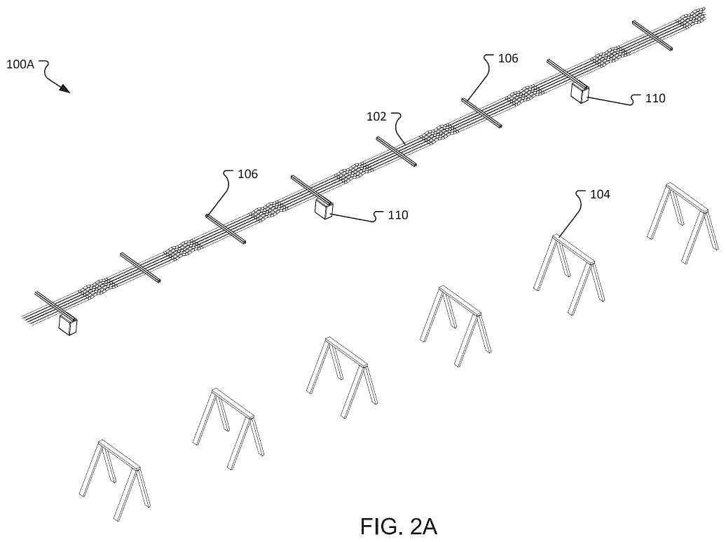

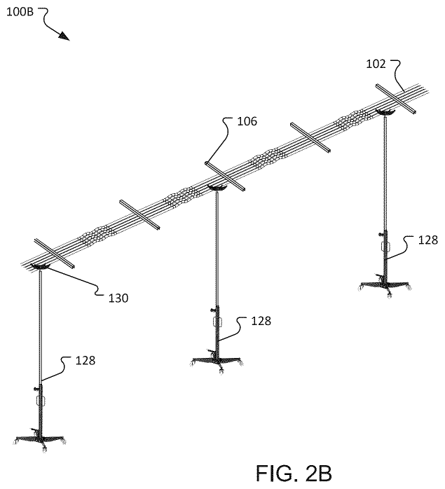

FIG. 2B illustrates the system 100B for lifting and installing building components in a raised assembly phase, where the pre-assembled building component(s) 102 may be secured to the previously installed support bracket 106, in accordance with examples of the present disclosure. In this phase, the system 100B has successfully lifted the pre-assembled building component(s) 102 from the lowered assembly phase, as depicted in FIG. 1B, to an installation position, which may be a final installation position. In examples, the lift have completed their primary function of lifting the pre-assembled building component(s) 102 to the desired installation height. The saddle 130 may maintain the position of the pre-assembled building component(s) 102 while they are being securely fastened to the support bracket 106.

FIG. 2A illustrates the system 100A for lifting and installing building components in a raised assembly phase, where the pre-assembled building component(s) 102 may be secured to the previously installed support bracket 106, in accordance with examples of the present disclosure. In this phase, the system 100A has successfully lifted the pre-assembled building component(s) 102 from the lowered assembly phase, as depicted in FIG. 1A, to an installation position, which may be a final installation position.

The pre-assembled building component(s) 102, which may include conduit sections containing data/telecom cables, electrical/power cables, or a combination thereof, are shown securely suspended from the ceiling structure. The flexible portion 108, which can be an integral part of the conduit section, may allow for some degree of movement or flexing during the installation process, ensuring that the pre-assembled building component(s) 102 can be properly aligned and secured to the support bracket 106.

The support bracket 106, which may have been previously attached to the ceiling attach points, is used in the raised assembly phase. It provides a stable and secure connection point for the pre-assembled building component(s) 102. The support bracket 106 may be designed to accommodate various types of ceiling attach points and can be easily adjusted to ensure proper alignment and positioning of the pre-assembled building component(s) 102.

In the raised assembly phase, the cable winches 110 have completed their primary function of lifting the pre-assembled building component(s) 102 to the desired installation height. The cables, with their first end 112 connected to the cable winches 110 and their second end 114 secured to ceiling attach points, now serve to maintain the position of the pre-assembled building component(s) 102 while they are being securely fastened to the support bracket 106.

The use of multiple cable winches 110 and cables in the system 100A offers several advantages in the raised assembly phase. In certain aspects, by distributing the weight of the pre-assembled building component(s) 102 evenly among the cables, the system 100A can ensure a stable and secure installation process. Additionally, the use of multiple cable winches 110 can allow for fine adjustments to be made to the position of the pre-assembled building component(s) 102, ensuring proper alignment with the support bracket 106.

In certain aspects, once the pre-assembled building component(s) 102 are lifted to the desired installation height and aligned with the support bracket 106, they can be secured to the support bracket 106 using various means. The specific method of securing the pre-assembled building component(s) 102 to the support bracket 106 may depend on factors such as the type of building component(s), the weight of the component(s), and the specific requirements of the installation project.

Several means of securing the pre-assembled building component(s) 102 to the support bracket 106 are contemplated. These may include, but are not limited to, the use of mechanical fasteners such as ties, bolts, screws, or clamps; the use of welding or soldering techniques; the use of adhesives or epoxies; or the use of specialized mounting hardware designed for the specific type of building component(s) being installed. In some cases, a combination of these securing methods may be employed to ensure a robust and stable connection between the pre-assembled building component(s) 102 and the support bracket 106.

For example, when installing conduit sections containing electrical/power cables, the pre-assembled conduit sections may be secured to the support bracket 106 using a combination of bolts and specialized clamps. These clamps can be designed to fit securely around the conduit and provide a strong, stable connection to the support bracket 106. In another example, when installing data/telecom cables, the cables may be secured to the support bracket 106 using cable ties or specialized cable management hardware designed to organize and secure the cables in place.

The choice of securing method(s) can depend on the specific requirements of the installation project, including factors such as local building codes, safety regulations, and the preferences of the installation team. Regardless of the specific securing method(s) used, the goal is to ensure that the pre-assembled building component(s) 102 are securely fastened to the support bracket 106, allowing for a safe, stable, and long-lasting installation.

By providing flexibility in the means of securing the pre-assembled building component(s) 102 to the support bracket 106, the system 100A can accommodate a wide range of installation scenarios and building component types. This adaptability further enhances the versatility and efficiency of the system 100A, making it suitable for use in a variety of construction projects.

The raised assembly phase, as depicted in FIG. 2A, highlights the efficiency and cost-saving benefits of the system 100A. By utilizing pre-assembled building component(s) 102, a streamlined lifting process, and a previously installed support bracket 106, the system 100A can reduce the time and labor required for on-site assembly and installation. This not only translates to lower labor costs but can also minimize the need for scaffolding or temporary support structures, further enhancing the overall safety and efficiency of the installation process.

Moreover, the use of pre-assembled building component(s) 102 in the system 100A helps to ensure a higher level of quality control and consistency. By assembling the conduit sections and cables in a controlled environment prior to installation, potential issues or defects can be identified and addressed early on, reducing the likelihood of costly delays or rework during the installation phase.

FIG. 2B illustrates the system 100B for lifting and installing building components in a raised assembly phase, where the pre-assembled building component(s) 102 may be secured to the previously installed support bracket 106, in accordance with examples of the present disclosure. In this phase, the system 100B has successfully lifted the pre-assembled building component(s) 102 from the lowered assembly phase, as depicted in FIG. 1B, to an installation position, which may be a final installation position. In examples, the lift have completed their primary function of lifting the pre-assembled building component(s) 102 to the desired installation height. The saddle 130 may maintain the position of the pre-assembled building component(s) 102 while they are being securely fastened to the support bracket 106.

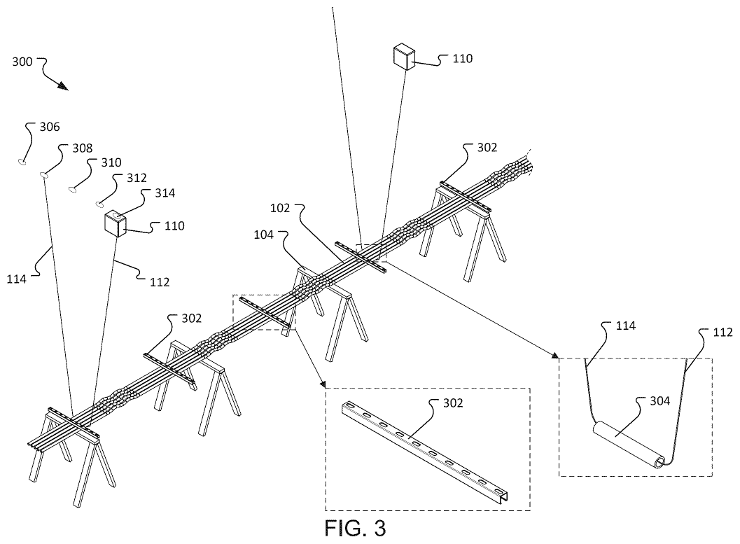

FIG. 3 illustrates a system 300 for lifting and installing building components in a lowered assembly phase, where a support bracket is attached to the pre-assembled building component(s) before being raised, in accordance with examples of the present disclosure. This configuration allows for the pre-assembled building component(s) to be securely fastened to the support bracket at ground level, which can simplify the installation process and reduce the need for overhead work.

The support bracket 302 can be the same as or different from the support bracket 106 described in previous figures. However, a distinguishing feature of the support bracket 302 is that it can be attached to the pre-assembled building component(s) 102 before being raised. This allows for a secure and stable connection between the pre-assembled building component(s) 102 and the support bracket 302, as the attachment can be performed at ground level where it is easier to ensure proper alignment and fastening.

Once the pre-assembled building component(s) 102 are securely attached to the support bracket 302, the entire assembly can be lifted to the desired installation height using the cable winches 110 and cables. The support bracket 302 can then be fastened to at least some of the ceiling attach points, providing a stable and secure connection between the pre-assembled building component(s) 102 and the ceiling structure.

In some aspects, a larger sleeve 304 may be used to support one or more pre-assembled building components 102. This sleeve 304 can be designed to accommodate multiple building components, such as several conduit sections or cable runs, and can help to organize and protect the components during the lifting and installation process. The sleeve 304 can be made from a durable, lightweight material such as plastic or fabric, and can be easily attached to or removed from the pre-assembled building component(s) 102 as needed.

In certain aspects, the system 300 in FIG. 3 also includes several ceiling attach points that can be used to secure the various components of the lifting and installation system. The ceiling attach point 306 may be used for securing the second end of the cable 114, while the ceiling attach point 308 may be used for securing either the support bracket 302 or the second end of the cable 114, depending on the specific installation requirements.

Ceiling attach points 310 and 312 may be primarily intended for securing the support bracket 302 to the ceiling structure. These attach points can be strategically located to ensure that the support bracket 302 is securely fastened and properly aligned with the pre-assembled building component(s) 102. The number and location of these attach points may vary depending on factors such as the size and weight of the pre-assembled building component(s) 102, the layout of the ceiling structure, and any relevant building codes or safety regulations.

The ceiling attach point 314 may serve multiple purposes, potentially being used to secure the support bracket 302 or the cable winch 110. The specific use of this attach point can depend on the particular installation scenario and the preferences of the installation team. By providing flexibility in the use of the ceiling attach points, the system 100A can accommodate a wide range of installation configurations and requirements.

At least one advantage of the configuration shown in FIG. 3 is that it allows for a significant portion of the installation work to be performed at ground level. By attaching the pre-assembled building component(s) 102 to the support bracket 302 before lifting, the installation team can ensure that the components are properly aligned and securely fastened without the need for extensive overhead work. This can reduce the time and effort required for installation, as well as improve safety by minimizing the need for workers to perform tasks at elevated heights.

Overall, the system 300 as depicted in FIG. 3 offers a versatile and efficient approach to lifting and installing building components. By allowing for the pre-assembled building component(s) 102 to be attached to the support bracket 302 at ground level and then lifted into place, this configuration streamlines the installation process and provides a secure and stable connection between the components and the ceiling structure.

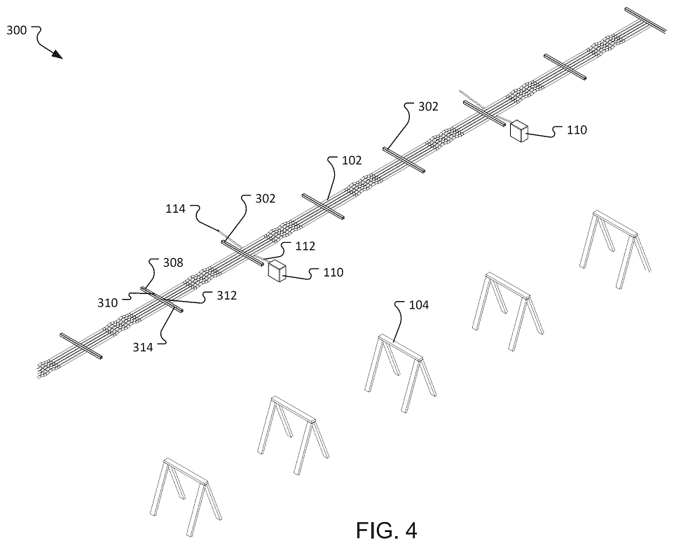

FIG. 4 illustrates the system 300 for lifting and installing building components in a raised assembly phase, where the support bracket 302 coupled to the pre-assembled building component(s) 102 can be attached to one or more ceiling attach points, in accordance with examples of the present disclosure. This phase demonstrates the system 300 after the pre-assembled building component(s) 102 and the attached support bracket 302 have been lifted from the lowered assembly phase, as depicted in FIG. 3, to the final installation position.

In this raised assembly phase, the pre-assembled building component(s) 102, which may include conduit sections containing data/telecom cables, electrical/power cables, or a combination thereof, are securely suspended from the ceiling structure via the support bracket 302. The support bracket 302, which was attached to the pre-assembled building component(s) 102 during the lowered assembly phase, now serves as the primary connection point between the building component(s) and the ceiling structure.

As depicted in FIG. 4, the cable winches 110 have successfully lifted the pre-assembled building component(s) 102 and the support bracket 302 to the desired installation height. The cables, with their first end 112 connected to the cable winches 110 and their second end 114 secured to ceiling attach points, now maintain the position of the assembly while the support bracket 302 is being fastened to the designated ceiling attach points.

The use of multiple cable winches 110 and cables in the system 300 ensures a stable and secure lifting process, as the weight of the pre-assembled building component(s) 102 and the support bracket 302 is evenly distributed among the cables. This not only reduces the strain on individual components but also allows for precise adjustments to be made during the installation process, ensuring proper alignment between the support bracket 302 and the ceiling attach points.

The ceiling attach points, including 308, 310, 312, and 314, can provide structural support for the pre-assembled building component(s) 102 and the support bracket 302. The specific configuration and use of these attach points may vary depending on factors such as the size and weight of the pre-assembled building component(s) 102, the layout of the ceiling structure, and any relevant building codes or safety regulations.

Ceiling attach points 310 and 312 can be primarily used for securing the support bracket 302 to the ceiling structure, ensuring a stable and reliable connection. Attach point 314 may serve as an additional connection point for the support bracket 302 or as a mounting point for the cable winch 110, depending on the specific installation requirements. Attach point 308 may be used for securing the support bracket 302 or the second end of the cable 114, providing flexibility in the installation process.

The raised assembly phase, as shown in FIG. 4, illustrates the efficiency and cost-saving advantages of the system 300. By pre-assembling the building component(s) 102 and attaching them to the support bracket 302 at ground level, a significant portion of the installation work can be completed before lifting, reducing the need for overhead work and minimizing the time spent working at elevated heights. This not only can improve safety but can also streamline the installation process, leading to reduced labor costs and faster project completion times.

Furthermore, the system 300 allows for greater precision and quality control, as the pre-assembled building component(s) 102 and the support bracket 302 can be thoroughly inspected and tested before being lifted into place. This reduces the likelihood of errors or defects occurring during the installation process, ultimately resulting in a higher-quality installation that meets the required specifications and standards.

In summary, FIG. 4 depicts the system 300 in its raised assembly phase, where the pre-assembled building component(s) 102 and the attached support bracket 302 are securely suspended from the ceiling structure using the cables connected to the cable winches 110. The support bracket 302 is then fastened to the designated ceiling attach points, providing a stable and reliable connection. This phase emphasizes the efficiency, safety, and cost-saving benefits of the system 300, which streamlines the installation process by allowing for pre-assembly and attachment of components at ground level before lifting them into their final installation position.

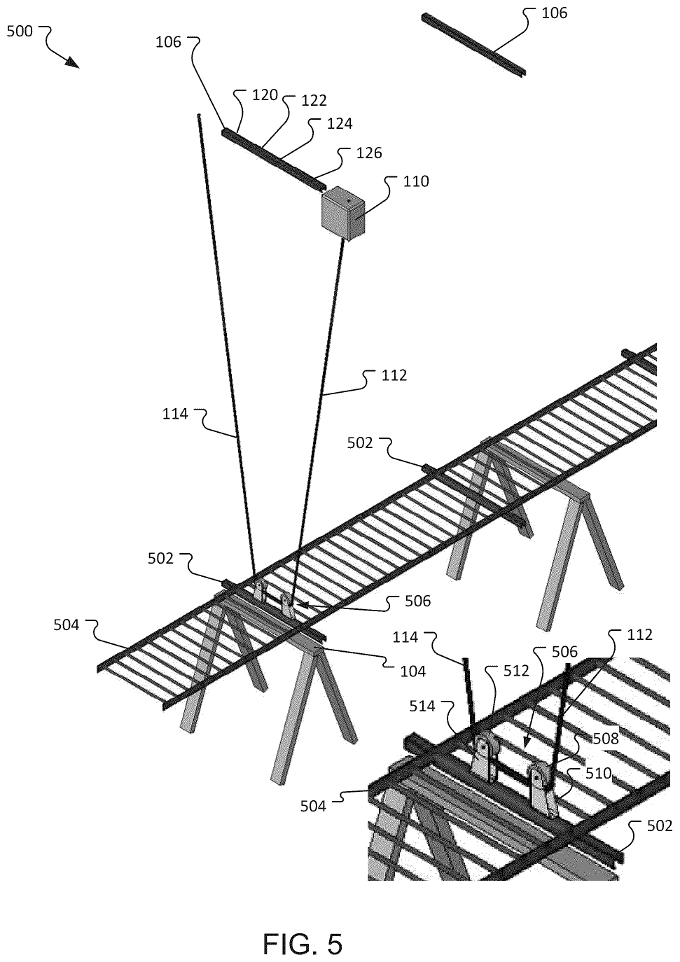

FIG. 5 illustrates a system 500 for lifting and installing building components in a lowered assembly phase, where a support bracket may be attached to a data tray assembly, allowing the pre-assembled building component(s) to be securely attached to the data tray assembly prior to being raised, in accordance with examples of the present disclosure. This configuration provides an additional level of organization and support for the pre-assembled building component(s), particularly when installing data/telecom cables or other components that require a structured pathway.

The support bracket 502 serves as the primary connection point between the data tray assembly 504 and the ceiling structure. In some aspects, the support bracket 502 may be a Unistrut® or a similar type of versatile mounting system that allows for easy attachment and adjustment of the data tray assembly 504. The support bracket 502 can be designed to be securely fastened to the ceiling structure using appropriate hardware and methods, such as bolts, screws, or welding, depending on the specific requirements of the installation.

Attached to the support bracket 502 is the data tray assembly 504, which can provide a organized pathway for the pre-assembled building component(s) 102, such as data/telecom cables or other related components. The data tray assembly 504 may comprise one or more cable trays, ladders, or similar structures that are designed to support and protect the cables while maintaining proper separation and organization. The data tray assembly 504 can be made from various materials, such as metal or plastic, depending on the specific application and environmental conditions.

To facilitate the lifting and positioning of the pre-assembled building component(s) 102 and the data tray assembly 504, the system 500 can include one or more pulley assemblies 506 and 512. These pulley assemblies can be attached to the support bracket 502 and provide a means for routing the cables (e.g., 112/114) connected to the cable winches 110.

In certain aspects, pulley assembly 506 comprises a pulley 508 through which the cable (e.g., 112/114) is routed. The pulley 508 can be designed to rotate freely, allowing the cable to move smoothly and efficiently during the lifting process. The pulley 508 can be coupled to the support bracket 502 via a pulley support bracket 510, which securely holds the pulley in place while allowing it to rotate. The pulley support bracket 510 can be adjusted or repositioned as needed to ensure optimal cable routing and to accommodate different installation configurations.

Similarly, pulley assembly 512 can include a pulley 514 through which the cable (e.g., 112/114) is routed. Pulley 514 can be coupled to the support bracket 502 via a pulley support bracket 516, which serves the same purpose as pulley support bracket 510. Although FIG. 5 depicts two pulley assemblies, it is important to note that the system 500 may include one, two, or more pulley assemblies, depending on the specific requirements of the installation and the number of cable winches 110 being used.

The use of pulley assemblies 506 and 512 in the system 500 offers several advantages. First, they provide a clear and organized path for the cables, reducing the risk of tangling or interference with other components. Second, the pulleys allow for smooth and efficient movement of the cables during the lifting process, minimizing friction and wear on the cables. Third, the adjustable nature of the pulley support brackets allows for optimal positioning of the pulleys, ensuring that the cables are properly aligned with the cable winches 110 and the pre-assembled building component(s) 102.

In the lowered assembly phase, as shown in FIG. 5, the pre-assembled building component(s) 102 can be securely attached to the data tray assembly 504, which is in turn connected to the support bracket 502. This allows for easy organization and management of the cables or other components, as well as simplified attachment of the entire assembly to the ceiling structure once it is lifted into place.

By utilizing the system 500, the installation process for data/telecom cables or other components requiring a structured pathway can be greatly streamlined. The pre-assembled building component(s) 102 can be quickly and easily attached to the data tray assembly 504 at ground level, reducing the need for overhead work and minimizing the risk of errors or damage during installation. Additionally, the use of pulley assemblies can ensure a smooth and efficient lifting of the entire assembly, further enhancing the overall efficiency and safety of the installation process.

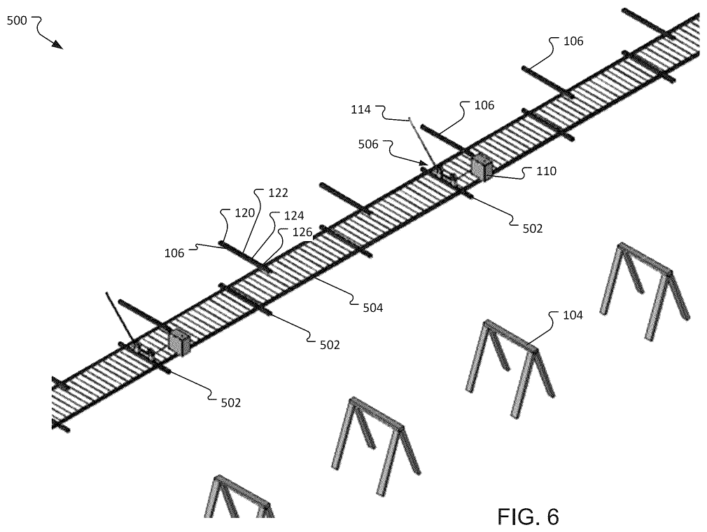

FIG. 6 illustrates the system 500 for lifting and installing building components in a raised assembly phase, where the support bracket 502 can be coupled to one or more ceiling attach points (e.g., 120-126) or to the support bracket 106, in accordance with examples of the present disclosure. This phase depicts the system 500 after the pre-assembled building component(s) 102, which may include components such as cables or other elements, have been lifted from the lowered assembly phase, as shown in FIG. 5, to their final installation position.

In this raised assembly phase, the pre-assembled building component(s) 102 can be securely suspended from the ceiling structure via the support bracket 502 and the data tray assembly 504. The data tray assembly 504 can provide an organized and structured pathway for the building component(s) 102, ensuring proper separation, protection, and management of the cables or other components throughout the installation process and during future maintenance or upgrades.

The support bracket 502, which is attached to the data tray assembly 504, is now positioned for secure attachment to the designated ceiling attach points or to the support bracket 106. The ceiling attach points (e.g., 120-126) are strategically located on the ceiling structure to provide support and stability for the installed components. These attach points may be pre-existing or installed specifically for the purpose of accommodating the system 500.

In some aspects, the support bracket 502 may be coupled directly to the ceiling attach points using appropriate fasteners, such as bolts, screws, or anchors. This direct attachment method provides a strong and stable connection between the support bracket 502 and the ceiling structure, ensuring that the installed components remain securely in place over time.

Alternatively, the support bracket 502 may be coupled to the support bracket 106, which is also attached to the ceiling structure. This configuration allows for added flexibility and adjustability in the positioning of the installed components. The support bracket 106 may be designed to accommodate various types of attachments, such as the support bracket 502 or other compatible hardware, providing a modular and adaptable solution for different installation scenarios.

The pulley assemblies 506 and 512, which were used during the lifting process in the lowered assembly phase, can remain attached to the support bracket 502 in the raised assembly phase. Although their primary function has been completed, the pulley assemblies may serve additional purposes, such as providing support for the cables or acting as guides to maintain proper cable routing and organization.

The raised assembly phase, as depicted in FIG. 6, depicts the efficiency and cost-saving advantages of the system 500. By allowing for the pre-assembly and organization of the building component(s) 102 on the data tray assembly 504 at ground level, the system 500 can reduce the time and effort required for overhead installation work. This not only minimizes the need for scaffolding or ladders but can also improves the overall safety of the installation process by reducing the risk of accidents associated with working at heights.

Moreover, the system 500 can enable a high degree of precision and quality control in the installation of the building component(s) 102. The pre-assembled components can be thoroughly inspected, tested, and adjusted as needed before being lifted into their final position, ensuring that they meet all necessary specifications and standards. This level of quality control helps to minimize the likelihood of errors or issues arising during or after the installation, ultimately resulting in a more reliable and efficient system.

Another advantage of the system 500 is its versatility in accommodating a wide range of building component(s) 102, including components such as cables or other elements. The data tray assembly 504 can be easily customized or adapted to support various types and sizes of components, making the system 500 suitable for a broad spectrum of installation projects across different industries and applications.

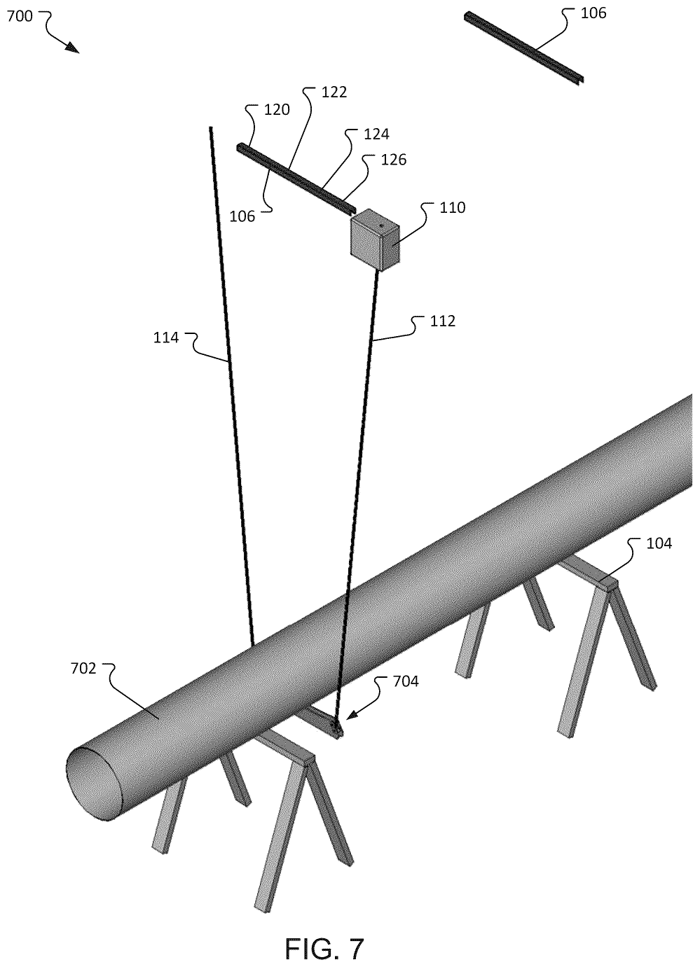

FIG. 7 illustrates the system 700 for lifting and installing building components, particularly focusing on the installation of a pre-assembled building component(s) 702 (such as a duct), in a lowered assembly phase, in accordance with examples of the present disclosure. This figure depicts the versatility of the lifting and installation system, as it can be adapted to accommodate various types of building components, such as ducts, in addition to the previously described cables and cable trays.

The pre-assembled building component in FIG. 7 is represented by a pre-assembled building component(s) 702 (such as a duct). Ducts are commonly used in buildings for heating, ventilation, and air conditioning (HVAC) systems to distribute conditioned air throughout the structure. In this example, the pre-assembled building component(s) 702 (such as a duct) is shown as a pre-assembled component, which means that it has been fabricated and prepared for installation prior to being brought to the construction site. This pre-assembly process can take place offsite, in a controlled environment, allowing for greater quality control, efficiency, and cost savings compared to traditional on-site fabrication methods.

The pre-assembled building component(s) 702 (such as a duct) is depicted in a lowered assembly phase, where it is positioned near the ground level or on a suitable work surface, such as the buckhorse 104. This lowered position allows for easy access to the pre-assembled building component(s) 702 (such as a duct) for any necessary preparations, adjustments, or inspections before it is lifted and installed in its final location.

To facilitate the lifting and positioning of the pre-assembled building component(s) 702 (such as a duct), the system 700 employs a pulleyed sleeve assembly 704. The pulleyed sleeve assembly 704 is an adaptation of the previously described pulley assemblies and sleeve assemblies, designed specifically to accommodate the unique shape and size of the pre-assembled building component(s) 702 (such as a duct).

The pulleyed sleeve assembly 704 comprises a sleeve or cradle-like structure that engages with the exterior surface of the pre-assembled building component(s) 702 (such as a duct). This sleeve is designed to distribute the lifting forces evenly along the length of the duct, preventing any localized stress or deformation during the lifting process. The sleeve material may be selected based on the specific requirements of the pre-assembled building component(s) 702 (such as a duct), taking into account factors such as weight, surface finish, and temperature resistance.

In certain aspects and integrated into the pulleyed sleeve assembly 704 are one or more pulleys, similar to those described in the pulley assemblies 506 and 512 of FIG. 5. These pulleys can be strategically positioned along the sleeve to provide a smooth and efficient path for the cables (e.g., 112/114) connected to the cable winches 110. The pulleys can allow for the cables to be routed along the length of the pre-assembled building component(s) 702 (such as a duct), ensuring a stable and controlled lift.

The pulleyed sleeve assembly 704 may be designed to be easily attached to and detached from the pre-assembled building component(s) 702 (such as a duct), allowing for efficient installation and removal as needed. This modular design enables the pulleyed sleeve assembly 704 to be used with different sizes and types of ducts, providing a flexible and adaptable solution for various HVAC installation projects.

In the lowered assembly phase, the pre-assembled building component(s) 702 (such as a duct), equipped with the pulleyed sleeve assembly 704, can be prepared for lifting and installation. This phase allows for any necessary adjustments to the pulleyed sleeve assembly 704, such as positioning the pulleys or securing the sleeve to the pre-assembled building component(s) 702 (such as a duct), to ensure a safe and efficient lift.

By utilizing the system 700, the installation of pre-assembled ducts can be greatly streamlined, reducing the time and labor required for on-site fabrication and installation. The pulleyed sleeve assembly 704 can enable the pre-assembled building component(s) 702 (such as a duct) to be easily lifted and positioned, minimizing the need for manual handling and reducing the risk of damage to the duct during the installation process.

Overall, FIG. 7 highlights the adaptability of the lifting and installation system to accommodate pre-assembled ducts, highlighting the efficiency and safety benefits of the pulleyed sleeve assembly 704. This versatility allows the system to be used across a wide range of building projects, from HVAC installations to other mechanical, electrical, and plumbing applications, ultimately leading to significant time and cost savings in the construction process.

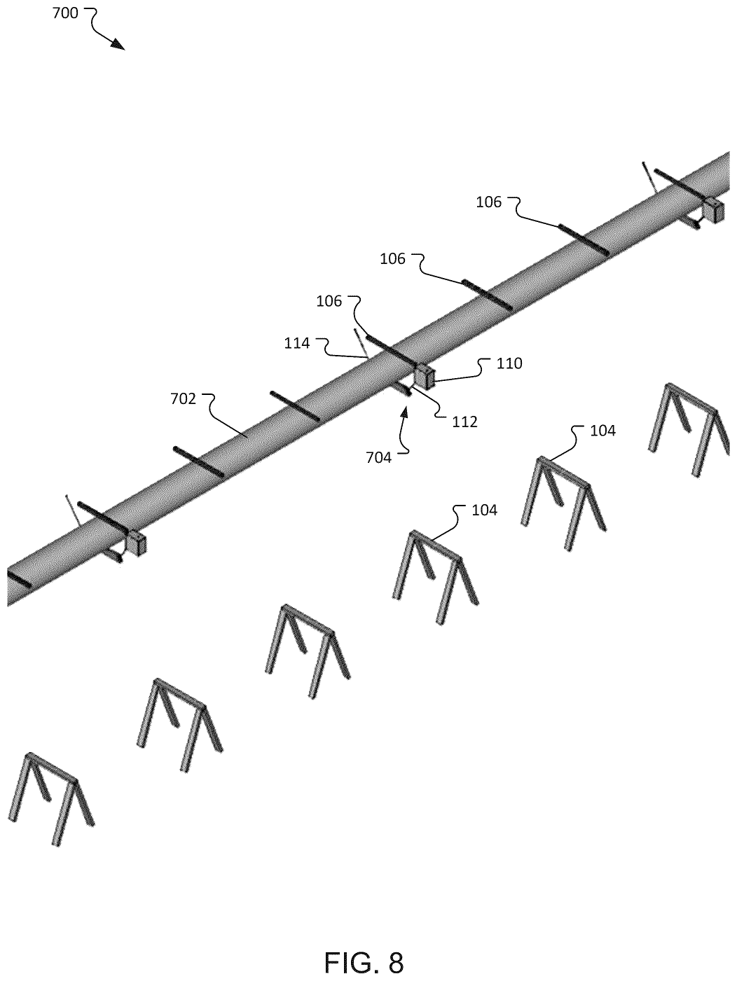

FIG. 8 illustrates the system 700 for lifting and installing building components in a raised assembly phase, where the pre-assembled building component(s) 702, exemplified as a duct, are connected to the support bracket 106, in accordance with examples of the present disclosure. This figure showcases the system's versatility in handling various types of building components, as the pre-assembled building component(s) 702 (such as a duct) is just one example, and the system can be adapted to accommodate other components such as pipes, conduits, or cable trays.

In this raised assembly phase, the pre-assembled building component(s) 702 have been successfully lifted from the lowered assembly phase, as depicted in FIG. 7, to a destination, such as a final installation position. The pre-assembled building component(s) 702 (such as a duct), which serves as an example of the pre-assembled building component(s), can be securely suspended from the ceiling structure via the support bracket 106.

The support bracket 106 provides a sturdy and reliable connection point between the pre-assembled building component(s) 702 and the ceiling structure. The support bracket 106 can be designed to distribute the weight of the building component(s) evenly, ensuring a stable and secure installation. In some aspects, the support bracket 106 may be adjustable, allowing for precise positioning and alignment of the pre-assembled building component(s) 702 during the installation process.

The pulleyed sleeve assembly 704, which was used in the lifting process during the lowered assembly phase, can remain attached to the pre-assembled building component(s) 702 in the raised assembly phase. Although its primary lifting function has been completed, the pulleyed sleeve assembly 704 can continue to provide support and stability to the pre-assembled building component(s) 702. The sleeve portion of the assembly helps to distribute the weight of the component(s) evenly, while the pulleys serve as guides for the cables (e.g., 112/114), ensuring that they remain properly positioned and organized.

The cables (e.g., 112/114) and cable winches 110 are also visible in FIG. 8, as they have played a crucial role in lifting the pre-assembled building component(s) 702 to their final position. In the raised assembly phase, the cables are tensioned to maintain the position of the pre-assembled building component(s) 702 while the support bracket 106 is securely fastened to the designated attachment points on the ceiling structure.

The raised assembly phase, as depicted in FIG. 8, highlights the efficiency and cost-saving benefits of the system 700. By utilizing pre-assembled building components, such as the pre-assembled building component(s) 702 (such as a duct), the installation process is greatly streamlined, reducing the time and labor required for on-site assembly. This pre-assembly approach allows for higher quality control, as the components can be fabricated and inspected in a controlled environment before being brought to the construction site.

Moreover, the system 700 can minimize the need for workers to perform tasks at elevated heights, as the majority of the assembly and preparation work can be completed at ground level. This not only improves worker safety but also reduces the reliance on scaffolding, ladders, or other temporary support structures, further contributing to the overall efficiency and cost-effectiveness of the installation process.

The adaptability of the system 700 to accommodate various types of pre-assembled building components, beyond just ducts, further enhances its value and versatility. The same principles and components, such as the support bracket 106, pulleyed sleeve assembly 704, cables, and winches, can be easily modified or scaled to suit the specific requirements of different building components. This flexibility allows the system to be used across a wide range of construction projects, from HVAC installations to plumbing, electrical, and mechanical applications.

In summary, FIG. 8 highlights the system 700 in its raised assembly phase, where the pre-assembled building component(s) 702, exemplified as a duct, can be securely installed and connected to the support bracket 106. This phase depicts the efficiency, safety, and cost-saving advantages of the system, which can enable the use of pre-assembled components, streamline the installation process, and minimize the need for overhead work.

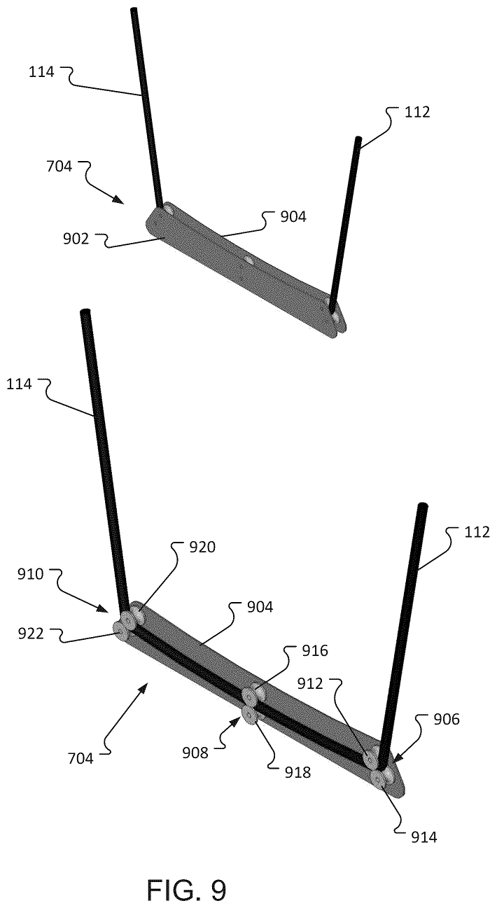

FIG. 9 provides a detailed illustration of the pulleyed sleeve assembly in accordance with examples of the present disclosure. In certain aspects, the pulleyed sleeve assembly is a component of the system for lifting and installing building components, such as ducts or pipes. In certain aspects, the pulleyed sleeve assembly 704 comprises two main faces: a front face 902 and a back face 904. These faces can be positioned parallel to each other and may be designed to engage with the exterior surface of the building component being lifted. For example, a curvature of a surface to be engaged with an exterior surface of the building component being lifted may conform to exterior surface of the building component. The front face 902 and back face 904 may be made of a durable, lightweight material, such as aluminum or a high-strength polymer, to ensure both strength and ease of handling during the installation process.

In certain aspects, integrated into the pulleyed sleeve assembly 704 can be several double pulley assemblies, which may be positioned to provide a smooth and efficient path for the cables used in the lifting process. The first double pulley assembly 906 can be located near the top of the pulleyed sleeve assembly 704 and comprise two pulleys, 908 and 910. These pulleys can be mounted on a common axle or shaft, allowing them to rotate freely and independently of each other. The double pulley configuration helps to distribute the load evenly and reduces friction on the cables as they pass through the assembly.

Similarly, the second double pulley assembly 912 can be positioned in the middle of the pulleyed sleeve assembly 704 and may include pulleys 914 and 916. Like the first double pulley assembly 906, these pulleys can be mounted on a shared axle, enabling smooth rotation and efficient cable movement. The placement of the second double pulley assembly 912 helps to maintain proper cable alignment and prevents any excessive sagging or slack in the cables during the lifting process.

The third double pulley assembly 918 can be located near the bottom of the pulleyed sleeve assembly 704 and features pulleys 920 and 922. This set of pulleys can guide the cables as they exit the pulleyed sleeve assembly 704 and helps to maintain proper tension and alignment. The positioning of the third double pulley assembly 918 helps to ensure that the cables remain organized and free from entanglement, even as the building component is lifted to a final installation position.

The use of double pulley assemblies in the pulleyed sleeve assembly 704 offers several advantages over single pulley designs. By distributing the load across two pulleys in each assembly, the system can reduce the stress on individual pulleys and cables, thereby extending their lifespan and minimizing the risk of failure. Additionally, the double pulley configuration can allow for smoother cable movement and reduces the amount of force required to lift the building component, resulting in a more efficient and user-friendly installation process.

The pulleyed sleeve assembly 704 can be designed to be easily attached to and detached from the building component being lifted. This may be achieved through the use of quick-release fasteners, straps, or clamps that securely hold the assembly in place during the lifting process. The ability to quickly and easily attach and detach the pulleyed sleeve assembly 704 further enhances the versatility and adaptability of the overall lifting system.

In summary, and in accordance with examples of the present disclosure, FIG. 9 provides a detailed view of the pulleyed sleeve assembly 704, showing its front face 902, back face 904, and the double pulley assemblies 906, 912, and 918. By incorporating the pulleyed sleeve assembly 704 into the larger system for lifting and installing building components, the installation process is can be streamlined, resulting in significant time and cost savings, as well as improved safety for workers on the construction site.

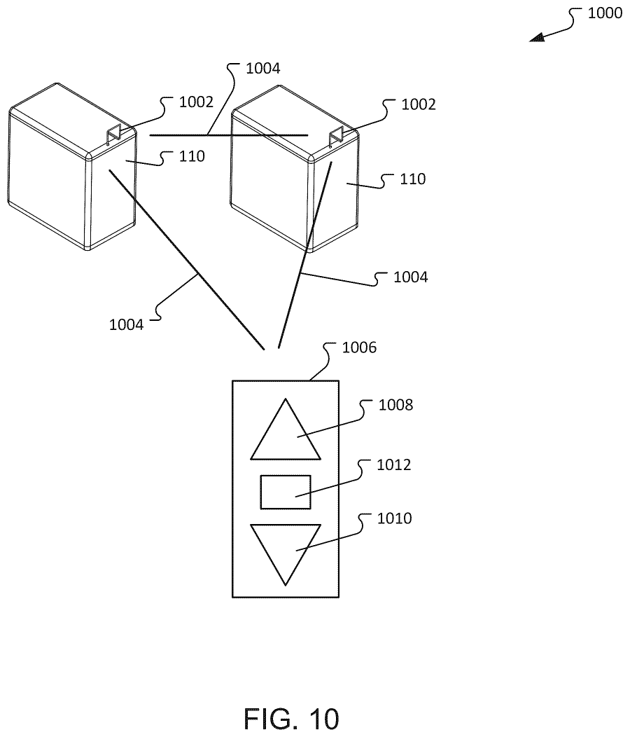

FIG. 10 illustrates an example communication system 1000 that can be used to control and operate the cable winches 110 in the system for lifting and installing building components in accordance with examples of the present disclosure. This communication system 1000 can enable remote and wireless control of the cable winches 110, providing a convenient and efficient means of adjusting the height and position of the building components during the installation process.

The communication system 1000 may include a controller 1006, which serves as the central processing unit and interface for controlling the cable winches 110. The controller 1006 can be a dedicated device, such as a custom-designed control panel, or it may be a programmable logic controller (PLC), a computer, or any other suitable device capable of processing user inputs and generating control signals for the cable winches 110. The controller 1006 may include a display screen, indicating lights, or other visual indicators to provide feedback and status information to the user during operation.

The controller 1006 can communicate with the cable winches 110 through a communication medium 1004. This communication medium 1004 can take various forms, depending on the specific requirements of the installation site and the preferences of the user. Common communication mediums include wireless technologies, such as radio frequency (RF) or Wi-Fi, wired connections, such as Ethernet or serial cables, or even infrared (IR) communication. The flexibility in communication options allows the system to be adapted to a wide range of installation environments and ensures compatibility with existing infrastructure.

In some aspects, and in the case of wireless communication, the controller 1006 and the cable winches 110 may be equipped with antennas 1002. These antennas 1002 facilitate the transmission and reception of wireless signals, enabling communication between the controller 1006 and the cable winches 110. The antennas 1002 may be integrated into the devices or externally attached, depending on the specific design requirements and the desired range of communication.

In some aspects, the controller 1006 features several buttons or input devices that allow a user to control the operation of the cable winches 110. The up button 1008, when pressed, sends a signal to the cable winches 110 to begin lifting the building component. This button may be held down to continuously raise the component or pressed briefly to incrementally adjust the height. Similarly, the down button 1010 can be used to lower the building component by signaling the cable winches 110 to release the cables in a controlled manner. The stop button 1012 can serve as safety feature that allows the user to immediately halt the movement of the cable winches 110 in case of an emergency or if any issues are detected during the lifting process.

The cable winches 110 can be equipped with communication modules that receive and interpret the signals sent by the controller 1006. These modules may include wireless receivers, wired communication ports, or IR sensors, depending on the chosen communication medium 1004. Upon receiving a command from the controller 1006, the cable winch 110 executes the corresponding action, such as raising, lowering, or stopping the movement of the cables.

The communication system 1000 offers several benefits to the overall system for lifting and installing building components. By enabling remote control of the cable winches 110, the communication system 1000 allows operators to adjust the height and position of the building components from a safe distance, reducing the need for workers to be in close proximity to the lifted loads. Additionally, the wireless nature of the communication system 1000 eliminates the need for cumbersome wires or cables running between the controller 1006 and the cable winches 110, improving the overall flexibility and mobility of the system.

Furthermore, the communication system 1000 can be easily integrated with other safety features, such as load sensors or emergency stop switches, to enhance the overall safety and reliability of the lifting process. For example, if a load sensor detects an imbalance or excessive stress on the cables, the controller 1006 can automatically stop the cable winches 110 and alert the operator to the potential issue.

In summary, FIG. 10 depicts an example communication system 1000 that enables remote and wireless control of the cable winches 110 in the system for lifting and installing building components. This communication system 1000, consisting of a controller 1006, antennas 1002, and a communication medium 1004, offers a convenient, efficient, and safe means of adjusting the height and position of the building components during the installation process. By integrating this communication system 1000 into the overall lifting system, the installation process can be streamlined, and the safety and flexibility of the system can be greatly enhanced.

It should be understood that while the example communication system 1000 has been described with reference to controlling and operating the cable winches 110, the system is not limited to this specific application. The communication system 1000 can be adapted to control and operate other lifting systems covered within the scope of this disclosure. For example, the system could be configured to control and operate the lift 128 as shown in FIGS. 1B and 2B. This adaptability allows the communication system 1000 to be utilized across various aspects of a lifting and installation system, providing a versatile solution for different types of building component installations. The controller 1006, antennas 1002, and communication medium 1004 can be modified or reprogrammed as necessary to accommodate the specific requirements of alternative lifting mechanisms, while maintaining the core functionality of remote and wireless control for efficient and safe installation processes.

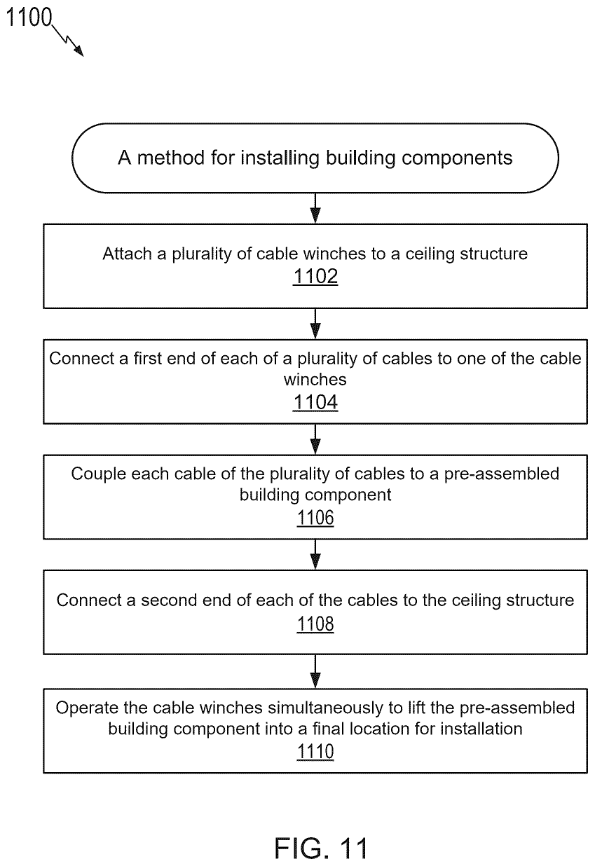

Referring now to FIG. 11, there is shown a flow diagram illustrating a method 1100 for installing building components using the system for lifting and installing pre-assembled building components, as discussed in the foregoing detailed description and earlier figures, and in accordance with aspects of the present disclosure. FIG. 11 presents a structured approach to coupling each cable of a plurality of cables to a pre-assembled building component, further facilitating the controlled and safe elevation of the building components into their final installation positions.

The initiation of the method 1100 described in FIG. 11 can involve attaching a plurality of cable winches to a ceiling structure. Each cable winch may be designed for handling substantial loads, thereby accommodating weight and shape of the pre-assembled building components. The strategic positioning of the winches across the ceiling structure helps to ensure a balanced distribution of mechanical stresses during the lifting process, minimizing any potential risks of structural overload.

Further in this step, the cable winches can be systematically configured in alignment with the layout of the pre-assembled components and the ceiling structure's load-bearing points. This configuration allows for an optimized pathway for the cables, ensuring a smooth transition from a non-tensioned to a tensioned state as the lifting process commences.

Continuing to box 1102, the method 1100 can involve connecting a first end of each cable from the plurality of cables to one of the cable winches installed in method 1100. This connection forms a primary linkage through which the lifting force is transmitted from the winches to the building components. The cables used here can be selected based on their strength, durability, and flexibility, which are vital characteristics that ensure the safety and reliability of the lifting process.

Each connection point between the cable and the winch can feature a secure fastening mechanism that prevents slippage and disengagement under load. These mechanisms include, but are not limited to, locking carabiners, industrial-grade clamps, or integrated cable loops.

In box 1104, the second end of each cable can be connected to the ceiling structure. This step helps to establish the stationary anchor points for the cables, which maintain the stability of the lifted components throughout the installation process. The ceiling anchor points can be pre-selected based on structural analyses to ensure that they can safely bear the loads imparted by the cables during lifting.

The attachment devices used at these anchor points can be designed for easy adjustment and locking, allowing for precise control over the tension in the cables. These devices may include tensioning bolts, heavy-duty hooks, or adjustable clamps, each selected based on the specific requirements of the installation environment and the characteristics of the ceiling structure.

At box 1106, method 1100 proceeds to coupling each cable of the plurality of cables to a pre-assembled building component. This coupling can involve the handling and positioning of the building components, which may include large and complex assemblies such as HVAC units, electrical conduits, or structural beams.

The method 1100 employs coupling devices that securely attach the cables to the building components without causing damage or undue stress. These devices can be designed to distribute the load evenly across the attachment points on the component, minimizing any potential for deformation or failure during lifting. Each coupling point is also equipped with safety features, such as fail-safe latches or redundant locking mechanisms, to ensure that the connection remains secure throughout the lifting operation.

Box 1108 outlines the operation of the cable winches simultaneously to lift the pre-assembled building component into a location for installation. This operation involves the coordinated action of the cable winches to provide the controlled and steady ascent of the building components to their designated positions within the structure. During this step, the winches can be operated under strict control protocols to maintain synchronous lifting, which helps to preserve balance and alignment of the components as they are elevated. Advanced control systems, possibly incorporating feedback sensors and automated control software, can be used to monitor and adjust the speed and force output of each winch, ensuring a smooth and incident-free installation process.

### Example Clauses

Implementation examples are described in the following numbered clauses:
Clause 1: A system for lifting and installing building components, including: a plurality of cable winches configured for attachment to a ceiling structure; a plurality of cables, each having a first end connected to one of the cable winches and a second end configured for connection to the ceiling structure, where each cable is coupled to a pre-assembled building component; and a control mechanism designed to operate the cable winches simultaneously to elevate the pre-assembled building component to its final installation location.
Clause 2: The system of Clause 1, wherein the pre-assembled building component includes a conduit section that contains at least one type of cable selected from data cables, telecom cables, electrical cables, and power cables.
Clause 3: The system according to any one of Clauses 1-2, further comprising a support bracket configured to secure the pre-assembled building component to the ceiling structure.
Clause 4: The system of Clause 3, wherein the support bracket is pre-installed on the ceiling structure prior to the lifting of the pre-assembled building component.
Clause 5: The system of Clause 3, wherein the support bracket is attached to the pre-assembled building component before it is lifted.
Clause 6: The system of Clause 3, further including a data tray assembly attached to the support bracket, wherein the pre-assembled building component is secured to the data tray assembly.
Clause 7: The system of Clause 3, further comprising one or more pulley assemblies attached to the support bracket, each pulley assembly including a pulley and a pulley support bracket.
Clause 8: The system according to any one of Clauses 1-7, further comprising an under component sleeve assembly positioned between the plurality of cables and the pre-assembled building component.
Clause 9: The system of Clause 8, wherein the under component sleeve assembly is configured to evenly distribute the weight of the pre-assembled building component.
Clause 10: The system according to any one of Clauses 1-9, wherein the control mechanism includes a wireless communication system comprising a controller, multiple antennas, and a communication medium.
Clause 11: A method for installing building components, comprising the steps of attaching a plurality of cable winches to a ceiling structure; connecting a first end of each of several cables to one of the cable winches; coupling each cable to a pre-assembled building component; connecting a second end of each cable to the ceiling structure; and operating the cable winches simultaneously to lift the pre-assembled building component to its final installation location.
Clause 12: The method of Clause 11, wherein the pre-assembled building component comprises a conduit section containing at least one of data cables, telecom cables, electrical cables, or power cables.
Clause 13: The method according to any one of Clauses 11-12, further including the step of attaching a support bracket to the pre-assembled building component before lifting.
Clause 14: The method of Clause 13, wherein coupling each cable of the plurality of cables to the pre-assembled building component includes coupling each cable to one or more pulley assemblies, each comprising a pulley and a pulley support bracket.
Clause 15: The method according to any one of Clauses 11-14, further including pre-installing a support bracket on the ceiling structure prior to lifting the pre-assembled building component.
Clause 16: The method according to any one of Clauses 11-15, wherein coupling each cable of the plurality of cables to the pre-assembled building component involves positioning an under component sleeve assembly between each cable and the pre-assembled building component.
Clause 17: The method according to any one of Clauses 11-16, further including attaching a data tray assembly to a support bracket, and securing the pre-assembled building component to the data tray assembly.
Clause 18: The method according to any one of Clauses 11-17, wherein the pre-assembled building component is a duct, and coupling each cable of the plurality of cables to the pre-assembled building component involves supporting the pre-assembled building component with a pulleyed sleeve assembly comprising a sleeve and one or more pulleys.
Clause 19: The method of Clause 18, wherein the pulleyed sleeve assembly includes a front face and a back face configured to engage with the exterior surface of the duct, and multiple double pulley assemblies positioned between the front face and the back face.
Clause 20: A processing system, comprising means for performing a method in accordance with any one of Clauses 11-19.
Clause 21: A lifting system for installing building components, including: a plurality of cable winches configured for connection to a building structure; a plurality of cables, each cable having a first end connected to one of the cable winches and a second end configured for connection to the building structure; a support bracket designed for coupling to the building structure; at least one accessory selected from a group consisting of a pulley assembly and a sleeve assembly, each accessory facilitating the coupling of each cable of the plurality of cables to a pre-assembled building component; and a control mechanism for operating the cable winches simultaneously to lift the pre-assembled building component into its final installation location.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system for lifting and installing building components, comprising:
a plurality of cable winches adapted to be connected to a ceiling structure;
a plurality of cables, each cable having a first end connected to one of the cable winches and a second end adapted to be connected to the ceiling structure, wherein each cable of the plurality of cables is coupled to a pre-assembled building component; and
a control mechanism for operating the cable winches simultaneously to lift the pre-assembled building component into a final location for installation.

2. The system of claim 1, wherein the pre-assembled building component comprises a conduit section containing at least one of data cables, telecom cables, electrical cables, or power cables.

3. The system of claim 1, further comprising a support bracket adapted to secure the pre-assembled building component to the ceiling structure.

4. The system of claim 3, wherein the support bracket is pre-installed on the ceiling structure prior to lifting the pre-assembled building component.

5. The system of claim 3, wherein the support bracket is attached to the pre-assembled building component before being lifted.

6. The system of claim 3, further comprising a data tray assembly attached to the support bracket, wherein the pre-assembled building component is secured to the data tray assembly.

7. The system of claim 3, further comprising one or more pulley assemblies attached to the support bracket, each pulley assembly comprising a pulley and a pulley support bracket.

8. The system of claim 1, further comprising an under component sleeve assembly positioned between the plurality of cables and the pre-assembled building component.

9. The system of claim 8, wherein the under component sleeve assembly is configured to distribute a weight of the pre-assembled building component evenly.

10. The system of claim 1, wherein the control mechanism comprises a wireless communication system including a controller, a plurality of antennas, and a communication medium.

11. A method for installing building components, comprising:
attaching a plurality of cable winches to a ceiling structure;
connecting a first end of each of a plurality of cables to one of the cable winches;
coupling each cable of the plurality of cables to a pre-assembled building component;
connecting a second end of each of the cables to the ceiling structure; and
operating the cable winches simultaneously to lift the pre-assembled building component into a final location for installation.

12. The method of claim 11, wherein the pre-assembled building component comprises a conduit section containing at least one of data cables, telecom cables, electrical cables, or power cables.

13. The method of claim 11, further comprising attaching a support bracket to the pre-assembled building component before lifting.

14. The method of claim 13, wherein coupling each cable of the plurality of cables to the pre-assembled building component comprises coupling each cable of the plurality of cables to one or more pulley assemblies, each pulley assembly comprising a pulley and a pulley support bracket.

15. The method of claim 11, further comprising pre-installing a support bracket on the ceiling structure prior to lifting the pre-assembled building component.

16. The method of claim 11, wherein coupling each cable of the plurality of cables to the pre-assembled building component comprises positioning an under component sleeve assembly between the each cable of the plurality of cables and the pre-assembled building component.

17. The method of claim 11, further comprising:
attaching a data tray assembly to a support bracket; and
securing the pre-assembled building component to the data tray assembly.

18. The method of claim 11, wherein the pre-assembled building component is a duct, and coupling each cable of the plurality of cables to the pre-assembled building component comprises supporting the pre-assembled building component with a pulleyed sleeve assembly comprising a sleeve and one or more pulleys.

19. The method of claim 18, wherein the pulleyed sleeve assembly comprises a front face and a back face configured to engage with an exterior surface of the duct, and a plurality of double pulley assemblies positioned between the front face and the back face.

20. A lifting system for installing building components, comprising:
a plurality of cable winches adapted to be connected to a building structure;
a plurality of cables, each cable having a first end connected to one of the cable winches and a second end adapted to be connected to the building structure;
a support bracket adapted to be coupled to the building structure;
at least one accessory selected from the group consisting of a pulley assembly and a sleeve assembly, the at least one accessory adapted to facilitate coupling of each cable of the plurality of cables to a pre-assembled building component, wherein each cable of the plurality of cables is coupled to the pre-assembled building component through the at least one accessory; and
a control mechanism for operating the cable winches simultaneously to lift the pre-assembled building component into a final location for installation.
